(19) United States
(12) Patent Application Publication
(10) Pub. No.: US 2006/0061284 A1
(43) Pub. Date: Mar. 23, 2006

(54) Double-bulb lamp

(75) Inventor: Minoru Nishibori, Tokyo (JP)

Correspondence Address: JORDAN AND HAMBURG LLP, 122 EAST 42ND STREET, SUITE 4000, NEW YORK, NY, 10168, US

(73) Assignee: Truweal Incorporated, Tokyo (JP)

(21) Appl. No.: 11/184,677

(22) Filed: Jul. 18, 2005

(30) Foreign Application Priority Data
Sep. 22, 2004 (JP) 2004-274331

(51) Int. Cl. H01J 61/30; H01J 17/16

(52) U.S. Cl. 313/634

(57) ABSTRACT

A double-bulb lamp is provided including a double-ended type inner lamp (having an arc tube, first and second sealing portions on opposite sides of the arc tube, and first and second lead wires extending outwardly from the first and second sealing portions. An outer bulb containing the inner lamp has an end portion forming a sealing section through which the inner lamp first and second lead wires extend externally of the outer bulb. The outer bulb sealing section is located on the same side as the inner lamp first sealing portion. The inner lamp first sealing portion optionally has an extension. The outer bulb has a non-oxidizing atmosphere. inner lamp first sealing portion or the extension thereof is embedded in the outer bulb sealing section such that the inner lamp first lead wire fails to be exposed within the outer bulb.

### BACKGROUND OF THE INVENTION

1. Field of the Invention

The present invention relates to double-bulb lamps for use in general lighting, optical devices, and lamps for vehicles and, more particularly, to such a double-bulb lamp which can be used in luminaries fitted with halogen lamps (including a vehicle headlight for example) instead of a halogen lamp.

2. Description of the Related Art

Metal halide lamps or high-pressure discharge lamps, which emanate brighter light than ever, have been preferentially used as light sources for general lighting, optical devices, headlights and other various devices. With the recent trend toward downsizing of, for example, optical devices, increasing demands exist for more compact and longer-life light sources and for point sources and the like. Making compacter a discharge lamp as a light source necessarily means minimizing the internal cubic volume of the arc tube and shortening the length of each sealing portion. Such minimizing and shortening realizes shortening of the entire length of the discharge lamp to a limit.

However, such ultimate shortening necessarily requires that a molybdenum foil member to be embedded in each sealing portion be shortened in length and brought maximally closer to the arc tube, which will cause the sealing portion to be heated to an elevated temperature during lighting. The sealing portions of a discharge lamp, each of which serves to interconnect an inner electrode lead and an outer lead wire via a molybdenum foil member embedded therein, block intrusion of outside air into the arc tube by the hermetic seal function of the molybdenum foil member. However, minute voids, which are present in a portion extending from an extremity of each sealing portion to the molybdenum foil member along the outer lead wire, allow outside air to be fed to the molybdenum foil member therethrough. Since molybdenum foil begins to oxidize at about 370° C. in the presence of oxygen, supply of outside air to the molybdenum foil member causes oxidation of the molybdenum foil to proceed when the sealing portion is heated to a temperature of not less than the oxidizing temperature of molybdenum foil during lighting. The oxidation of the molybdenum foil member leads to shortening of the lifetime of the discharge lamp, thus causing the product quality to degrade.

Because there has been no demand for the aforementioned downsizing of a conventional discharge lamp, the place where the molybdenum foil member is to be embedded can be positioned away from the arc tube of which the temperature becomes elevated during lighting and, hence, oxidation of the molybdenum foil member does not occur even in the presence of oxygen.

Accordingly, it is an object of the present invention to prevent oxidation of molybdenum foil members even when the length of a discharge lamp is shortened to a limit.

### SUMMARY OF THE INVENTION

In one aspect of the present invention, there is provided a double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section of the outer bulb being located on the same side as the first sealing portion of the inner lamp, wherein: the first sealing portion of the inner lamp optionally has an extension; the outer bulb has a non-oxidizing atmosphere therein; and the first sealing portion of the inner lamp or the extension thereof is embedded in the sealing section of the outer bulb such that that the first lead wire of the inner lamp fails to be exposed within the outer bulb.

In another aspect of the present invention, there is provided a double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section being located opposite away from the second sealing portion of the inner lamp, wherein: the second sealing portion of the inner lamp has an extension; the outer bulb has a non-oxidizing atmosphere therein; and an end portion of the extension of the second sealing portion of the inner lamp is embedded in the sealing section of the outer bulb such that the second lead wire of the inner lamp fails to be exposed within the outer bulb.

In yet another aspect of the present invention, there is provided a double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section being located opposite away from the second sealing portion of the inner lamp, wherein: the outer bulb has a non-oxidizing atmosphere therein; and the second lead wire of the inner lamp is sheathed with an auxiliary insulating tube having an end embedded in the sealing section of the outer bulb.

In the double-bulb lamp of the present invention, the outer bulb has the non-oxidizing atmosphere therein; stated otherwise, the outer bulb is provided with vacuum therein or filled with inert gas therein. For this reason, even if the length of each of the first and second sealing portions is very short and, therefore, the length of the molybdenum foil member embedded within each sealing portion is short and the embedded position of the molybdenum foil member is close to the arc tube of which the temperature is elevated during lighting and even if voids are present in a portion extending from the extremity of each sealing portion to the molybdenum foil member along a respective one of the first and second lead wires, supply of oxygen to the molybdenum foil member is completely blocked and, hence, the molybdenum foil cannot be oxidized even when heated to a temperature of not less than the oxidizing temperature thereof. In addition, the first lead wire on the same side as the sealing section of the outer bulb or the second lead wire on the side opposite away from the sealing section fails to be exposed within the outer bulb, or the second lead wire is insulated from the first lead wire with the auxiliary insulating tube. For this reason, even if they extend side by side within the sealing section at one end of the outer bulb, the two lead wires are reliably insulated from each other, which will prevent the occurrence of leakage current even under application of high voltage upon starting of lighting.

In the case where the auxiliary insulating tube is used, it is sufficient to provide a spacing of about 15 to about 16 mm between the upper end of the auxiliary insulating tube and an exposed portion of the first lead wire extending from the first sealing portion of the inner lamp when the breakdown voltage (starting voltage) is 20,000V for example. If the outer bulb is filled with nitrogen, short circuit between the first and second lead wires can be inhibited.

The foregoing and other objects, features and attendant advantages of the present invention will become more apparent from the reading of the following detailed description of the invention in conjunction with the accompanying drawings.

### BRIEF DESCRIPTION OF THE DRAWINGS

FIG. 1 is a sectional view showing a double-bulb lamp according to one embodiment of the present invention;

FIG. 2 is a sectional view showing a double-bulb lamp according to a variation of the embodiment shown in FIG. 1;

FIG. 3 is a sectional view showing a double-bulb lamp according to another embodiment of the present invention;

FIG. 4 is a sectional view showing a double-bulb lamp according to a variation of the embodiment shown in FIG. 3; and

FIG. 5 is a sectional view showing a semi-finished inner lamp.

### DETAILED DESCRIPTION OF THE PREFERRED EMBODIMENTS

Hereinafter, embodiments of the present invention will be described in detail with reference to the accompanying drawings.

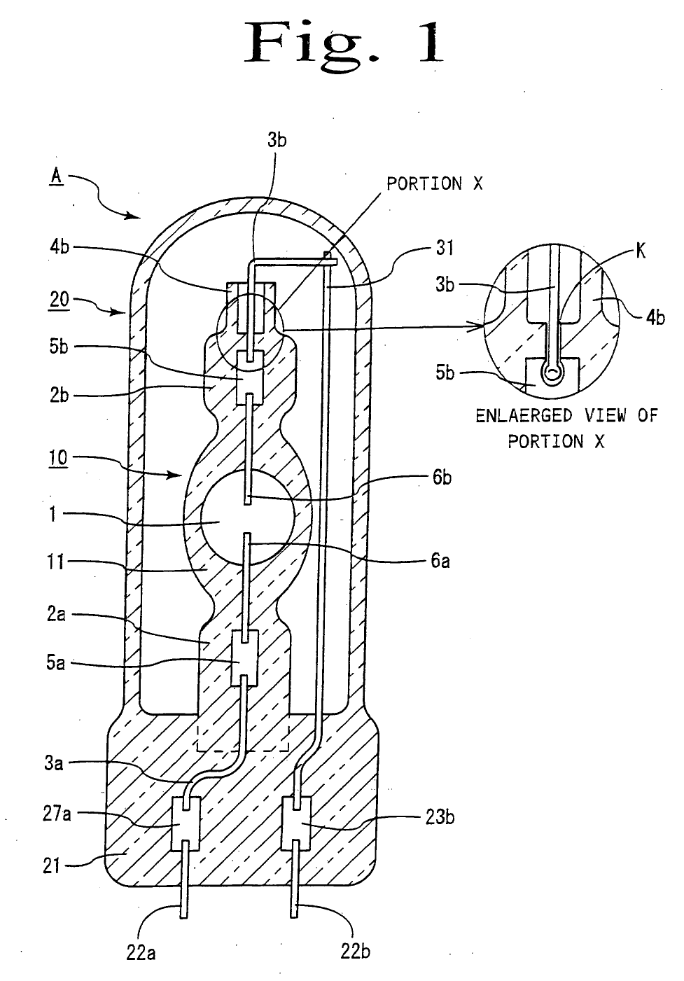

FIG. 1 is a sectional view showing a double-bulb lamp (A) according to one embodiment of the present invention. The double-bulb lamp (A) includes a light-emitting inner lamp 10 formed of quartz glass and an outer bulb 20. The inner lamp 10 includes an arc tube 1, an envelope 11 provided with first and second sealing portions 2a and 2b on opposite sides of the arc tube 1, a pair of electrodes 6a and 6b positioned as opposed to each other within the arc tube 1, molybdenum foil members 5a and 5b embedded within the first and second sealing portions 2a and 2b, respectively, and first and second lead wires 3a and 3b extending out of the first and second sealing portions 2a and 2b, respectively, the first and second lead wires 3a and 3b each having one end welded to a respective one of the molybdenum foil members 5a and 5b.

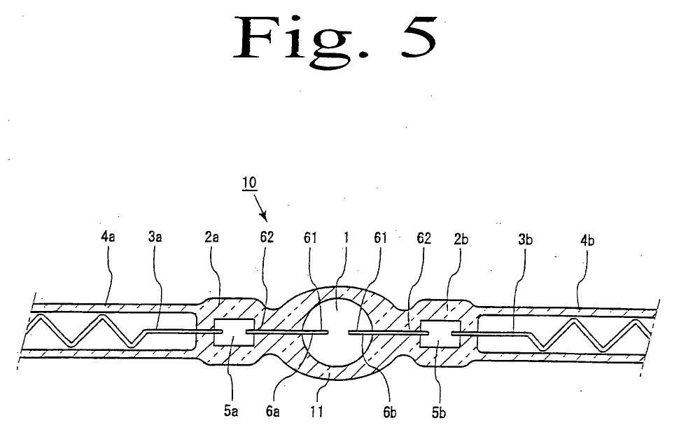

Within the arc tube 1 are encapsulated mercury, rare gas, and other necessary fillers. As shown in FIG. 5, the electrodes 6a and 6b each comprise a respective one of electrode heads 61,61 positioned as opposed to each other, and a respective one of electrode leads 62,62 extending out of the arc tube 1 from the respective electrode heads 61,61 and welded at their leading ends to the respective molybdenum foil members 5a and 5b. The electrode leads 62,62 are each embedded within a respective one of the first and second sealing portions 2a and 2b and each spot-welded to a respective one of the molybdenum foil members 5a and 5b. The first lead wire 3a extending on the sealing section 21 side has one end spot-welded to the molybdenum foil member 5a and an opposite end led out of the sealing portion 2a. On the other hand, the second lead wire 3b extending on the side opposite away from the sealing section 21 is bent halfway and connected at its leading end to an auxiliary outer lead wire 31, as shown in FIG. 1. Since the auxiliary outer lead wire 31 functions in the same way as the second lead wire 3b in this embodiment, the auxiliary outer lead wire 31 will be described as included in the second lead wire 3b unless the need arises to describe it separately from the second lead wire 3.

The outer bulb 20 has one end forming the sealing section 21 in which molybdenum foil members 23a and 23b are embedded to connect the first and second lead wires 3a and 3b to respective of external lead wires 22a and 22b extending externally of the outer bulb 20. If the outer bulb 20 is formed of hard glass having a thermal expansion coefficient substantially equal to that of the external lead wires 22a and 22b, the first and second lead wires 3a and 3b may be embedded in the sealing section 21 to extend therethrough, though not illustrated.

The sealing portions 2a and 2b and the sealing section 21 may be formed by shrink sealing or pinch sealing. Though pinch sealing is employed in the embodiment shown, there is no particular limitation thereto. Since the pair of molybdenum foil members 23a and 23b are positioned side by side within the sealing section 21 of the outer bulb 20, the sealing section 21 is preferably formed by pinch sealing. Though the head portion of the outer bulb 20 shown has a hemispherical configuration, there is no particular limitation thereto. The head portion of the outer bulb 21 may have a flat closed configuration like the sealing portion 2b of the inner lamp 10 or any other closed configuration formed by sealing.

The embodiment shown in FIG. 1 is an embodiment wherein: an end portion of the first sealing portion 2a of the inner lamp 10 is embedded within the sealing section 21 of the outer bulb 20; and the first lead wire 3a extending out of the first sealing portion 2a partially embedded within the sealing section 21 is connected to the molybdenum foil member 23a in the sealing section 21 without being exposed within the outer bulb 20.

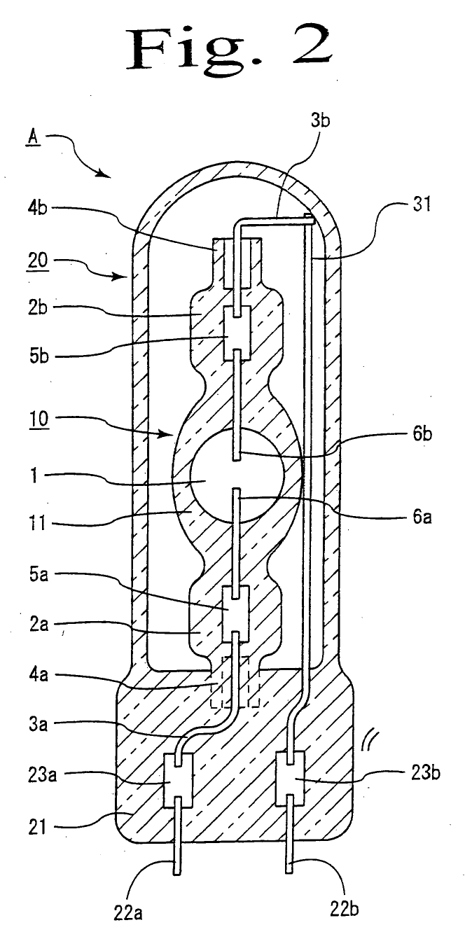

Another embodiment shown in FIG. 2 is an embodiment wherein: a cylindrical or planar extension 4a extending from the first sealing portion 2a located on the sealing section side is embedded within the sealing section 21 of the outer bulb 20; and the first lead wire 3a extending out of the first sealing portion 2a and through the extension 4a is connected to the molybdenum foil member 23a in the sealing section 21 without being exposed within the outer bulb 20.

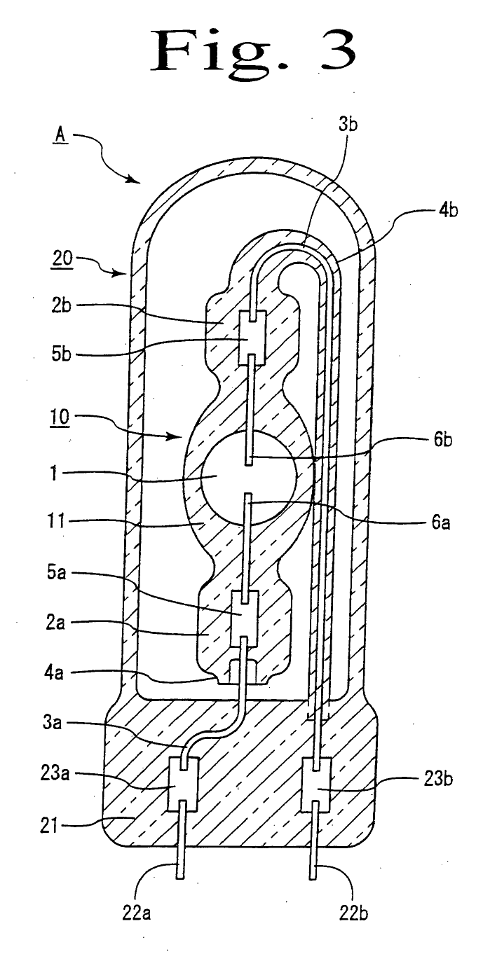

Yet another embodiment shown in FIG. 3 is an embodiment wherein: a thin extension 4b extending from the second sealing portion 2b located on the side opposite away from the sealing section 21 either integrally therewith or connected with a thin tubular member halfway, is bent to extend along the inner lamp 10 and the leading end of the extension 4b is embedded within the sealing section 21; and the second lead wire 3b extending out of the second sealing portion 2b and through the bent thin extension 4b is connected to the molybdenum foil member 23b in the sealing section 21 without being exposed within the outer bulb 20. In this embodiment, the first sealing portion 2a located on the sealing section 21 side is not embedded within the sealing section 21 and the first lead wire 3a extending out of the first sealing portion 2a is exposed within the outer bulb 20 and then inserted into the sealing section 21 to connect to the molybdenum foil member 23a therein. The first sealing portion 2a may have an end portion or extension 4a embedded within the sealing section 21, as in the embodiments shown in FIGS. 1 and 2. The embedded portions shown in FIGS. 1 to 3 are each formed substantially integrally with the sealing section 21 by fusion bonding. The external lead wires 22a and 22b of the outer bulb 20 are connected to the molybdenum foil members 23a and 23b, respectively, and extend externally of the outer bulb 20.

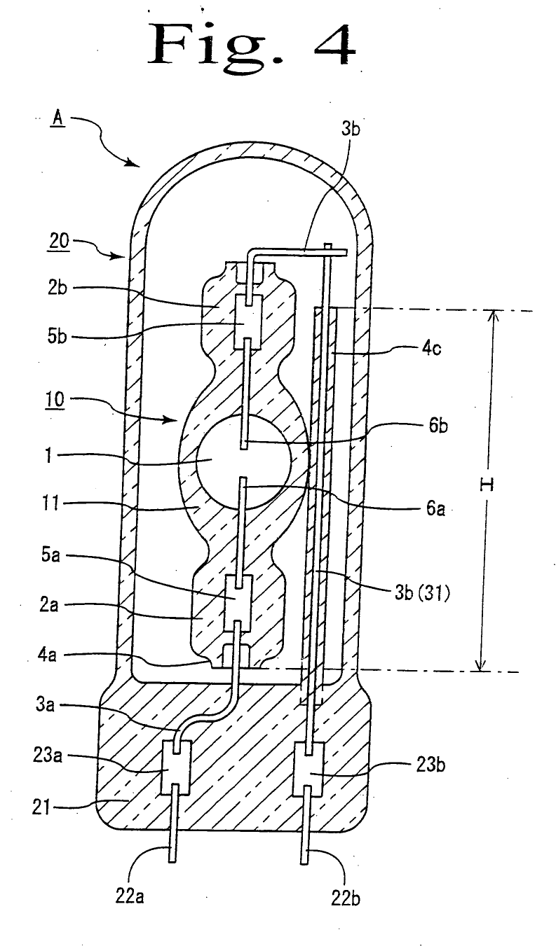

Yet another embodiment shown in FIG. 4 is an embodiment using an auxiliary insulating tube 4c wherein: the auxiliary insulating tube 4c has one end embedded within the sealing section 21 of the outer bulb 20; and a portion of the second lead wire 3b or its auxiliary lead wire 31 extending from the sealing section 21 to a location above the arc tube 1 is sheathed with the auxiliary insulating tube 4c. Though there is no particular limitation on the sheathing range, it is sufficient for the sheathing range to ensure spacing such as to prevent leakage current (short circuit due to discharge) from occurring between the two lead wires 3a and 3b under application of a high breakdown voltage (starting voltage.) A spacing of about 15 to about 16 mm is sufficient between the two lead wires 3a and 3b when the breakdown voltage is 20,000V for example. Accordingly, the sheathing range is a range such as to prevent leakage current (short circuit due to discharge) from occurring between the two lead wires 3a and 3b under application of a high breakdown voltage (starting voltage.)

The atmosphere within the outer bulb 20 is a substantially oxygen-free atmosphere; that is, the outer bulb 20 is substantially provided with vacuum therein or filled with inert gas such as nitrogen, argon gas or the like. The material of the outer bulb 20 may be either quartz glass or hard glass as mentioned earlier. However, in the case where the inner lamp 10 is partially embedded within the outer bulb 20, the outer bulb 20 is preferably formed of the same material as the inner lamp 10, i.e., quartz glass in view of thermal expansion coefficient. In the embodiment shown in FIG. 4 in which the inner lamp 10 and the outer bulb 20 are separate from each other, the outer bulb 20 may be formed of hard glass if the material of auxiliary insulating tube 4c is formed of hard glass.

Brief description will be made of a double-bulb lamp manufacturing method. The inner lamp 10 is formed as shown in FIG. 5. In the case of the embodiment shown in FIG. 1, one extension 4a is cut away from the first sealing portion 2a, while the other extension 4b cut away from the second sealing portion 2b to leave a remaining short extension 4b. Thereafter, the second lead wire 3b bent is spot-welded to the auxiliary lead wire 31 so as to extend along a lateral side of the inner lamp 10. Though the embodiment shown has the remaining short extension 4b of the second sealing portion 2b, the remaining extension 4b is preferably removed in order to further reduce the length of the lamp. If the second lead wire 3b and the auxiliary lead wire 31 spot-welded to each other, the auxiliary lead wire 31 is simply included in the definition of the second lead wire 3b. Note that the remaining extension 4b has a tubular configuration.

In the case of the embodiment shown in FIG. 2, opposite extensions 4a and 4b are cut away to leave remaining short extensions 4a and 4b. These extensions 4a and 4b each have a tubular configuration as in the embodiment shown in FIG. 1. Since one extension 4a needs to be embedded within the sealing section 21 of the outer bulb 20, the extension 4a may be deformed into a flat shape by heating when necessary.

In the case of the embodiment shown in FIG. 3, one extension 4a is cut away to leave a remaining short extension 4a (or not to leave any remaining extension), while the other extension 4b stretched into a thin tube (or connected with a non-illustrated thin auxiliary tube of the same material) and then bent at its base portion to extend along a lateral side of the inner lamp 10. The first and second lead wires 3a and 3b are welded at their respective ends to the molybdenum foil members 23a and 23b, respectively. Further, the external lead wires 22a and 22b to be led externally of the outer bulb 20 are welded to the molybdenum foil members 23a and 23b, respectively.

In the case of the embodiment shown in FIG. 4, the auxiliary lead wire 31 is inserted into the auxiliary insulating tube 4c and then spot-welded at its leading end to the molybdenum foil member 23b. Further, the external lead wire 22b is spot-welded to the other end of the molybdenum foil member 23b. The molybdenum foil member 23b and the leading end portion of the auxiliary insulating tube 4c are embedded within the sealing section 21 during sealing.

On the other hand, the outer bulb 20 has a tubular shape hemispherically closed at one end and open at the other end. Stated otherwise, the outer bulb 20 is in the form of a test tube. There is no particular limitation on the shape of the closed end, but the closed end of the outer bulb 20 may have a flat shape or other shape. The inner lamp 10 prepared as described above is inserted into the outer bulb 20 through the open end. With the inner lamp 10 being held as inserted in the outer bulb 20, the outer bulb 20 is connected to a non-illustrated evacuator and then evacuated to a substantially vacuum state (or filled with the aforementioned inert gas), followed by pinch-sealing of the open end by heating.

The double-bulb lamp (A) thus formed is fitted with a base (not shown.) In use, the double-bulb lamp (A) is attached to any one of various luminaries. During starting of lighting a high voltage is applied across the electrodes 6a and 6b to shorten the starting time. Since the first and second lead wires 3a and 3b extending from the inner lamp 10 are insulated from each other within the outer bulb 20, leakage of current (short circuit) cannot occur even under application of such a high voltage. During lighting the arc tube 1 is heated to an elevated temperature, hence, the sealing portions 2a and 2b located close to the arc tube 1 are exposed to an elevated temperature. It follows that the molybdenum foil members 5a and 5b embedded in the first and second sealing portions 2a and 2b are also heated to an elevated temperature. However, since the atmosphere within the outer bulb 20 is kept completely non-oxidizing, it is not possible that oxygen is supplied to the molybdenum foil members 5a and 5b from extremities of the respective sealing portions 2a and 2b through voids (K) formed along the lead wires 3a and 3b. For this reason, even when the molybdenum foil members 5a and 5b are heated to a temperature of not less than the oxidizing temperature thereof, the molybdenum foil members 5a and 5b cannot be oxidized. Accordingly, the lifetime of the double-bulb lamp can be prevented from being shortened due to oxidation of the molybdenum foil members 5a and 5b even if the length of the inner lamp 10 is shortened to a limit.

As described above, the present invention allows the length of a discharge lamp to be shortened to a limit while preventing the molybdenum foil members from oxidizing. Accordingly, the double-bulb lamp according to the present invention can accommodate to downsizing of devices and can be used instead of a halogen lamp used in a headlight for example.

The foregoing embodiments are illustrative in all points and should not be construed to limit the present invention. The scope of the present invention is defined not by the foregoing embodiment but by the following claims. Further, the scope of the present invention is intended to include all modifications within the meanings and scopes of claims and equivalents.

What is claimed is:

1. A double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section of the outer bulb being located on the same side as the first sealing portion of the inner lamp, wherein: the first sealing portion of the inner lamp optionally has an extension; the outer bulb has a non-oxidizing atmosphere therein; and the first sealing portion of the inner lamp or the extension thereof is embedded in the sealing section of the outer bulb such that that the first lead wire of the inner lamp fails to be exposed within the outer bulb.

2. A double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section being located opposite away from the second sealing portion of the inner lamp, wherein: the second sealing portion of the inner lamp has an extension; the outer bulb has a non-oxidizing atmosphere therein; and an end portion of the extension of the second sealing portion of the inner lamp is embedded in the sealing section of the outer bulb such that the second lead wire of the inner lamp fails to be exposed within the outer bulb.

3. A double-bulb lamp comprising: a double-ended type inner lamp having an arc tube, first and second sealing portions on opposite sides of the arc tube, and first and second lead wires extending outwardly from the first and second sealing portions, respectively; and an outer bulb containing the inner lamp therein and having an end portion forming a sealing section through which the first and second lead wires of the inner lamp extend externally of the outer bulb, the sealing section being located opposite away from the second sealing portion of the inner lamp, wherein: the outer bulb has a non-oxidizing atmosphere therein; and the second lead wire of the inner lamp is sheathed with an auxiliary insulating tube having an end embedded in the sealing section of the outer bulb.
